(19) United States
(12) Patent Application Publication
(10) Pub. No.: US 2020/0132130 A1
(43) Pub. Date: Apr. 30, 2020

(54) POWER TRANSMISSION DEVICE FOR A VEHICLE

(71) Applicant: EXEDY Corporation, Osaka (JP)

(72) Inventor: Keiichi YASUDA, Osaka (JP)

(73) Assignee: Exedy Corporation

(21) Appl. No.: 16/585,307

(22) Filed: Sep. 27, 2019

(30) Foreign Application Priority Data
Oct. 26, 2018 (JP) 2018-202289

(51) Int. Cl. F16D 3/80; F16F 15/16

(52) U.S. Cl. CPC F16D 3/80; F16H 45/02; F16F 15/161

(57) ABSTRACT

A power transmission device for a vehicle is disclosed. The power transmission device includes a first rotating member, a second rotating member configured to rotate relative to the first rotating member, a torque transmission portion, and a hydraulic pressure applying portion. The torque transmission portion is configured to transmit torque from one of the first rotating member and the second rotating member to the other of the first rotating member and the second rotating member by pressure of hydraulic fluid. The torque transmission portion is disposed between the first rotating member and the second rotating member. The hydraulic pressure applying portion is configured to apply pressure to the hydraulic fluid of the torque transmission portion.

### CROSS-REFERENCE TO RELATED APPLICATIONS

This application claims priority to Japanese Patent Application No. 2018-202289, filed Oct. 26, 2018. The contents of that application are incorporated by reference herein in their entirety.

### TECHNICAL FIELD

The present invention relates to a power transmission device for a vehicle.

### BACKGROUND ART

In a conventional power transmission device for a vehicle, for example, a damper device, an input rotating member and an output rotating member are connected by a coil spring (a torque transmission portion). In this case, when torque is input to the input rotating member, the coil spring is compressed between the input rotating member and the output rotating member. Further, when the torque fluctuation is input to the input rotating member, the elastic member expands and contracts between the input rotating member and the output rotating member.

Generally, in a damper device, when the frequency of torque fluctuation, which is input from the engine to the damper device, approaches the natural frequency of the damper device, the damper device can resonate. This phenomenon occurs when the engine speed approaches a predetermined speed (a resonance speed). See JP-A-10-196764.

Here, in the conventional damper device, the resonance rotational speed is often set to the low rotational speed side by reducing the rigidity of the spring of the damper device. In this case, since the resonance rotational speed is set on the low rotational speed side, the damper device can be operated without considering the resonance of the damper device in a range that is larger than the resonance rotational speed.

However, when the vehicle type or the engine type is changed, the resonance rotational speed changes. Therefore, in the conventional damper device, it is necessary to adjust the spring rigidity each time. For this reason, development of the damper apparatus which can easily set a spring (a torque transmission portion) is desired.

Further, in the conventional damper device, if it is attempted to reduce the spring stiffness, it is necessary to ensure the spring strength against the repeated stress acting on the spring, so that the spring diameter can be increased. As described above, in the conventional damper device, the size of the damper device can increase by enlargement of the spring diameter.

Also, the larger the damper device is, the greater the weight of the damper device is. Also, the larger the spring diameter is, the more difficult it is to arrange the spring in the damper device.

The present invention has been made in view of the above problems, and an object of the present invention is to provide a power transmission device for a vehicle that can easily set rigidity during torque transmission. Moreover, the objective of this invention is to achieve size reduction and weight reduction of the power transmission device for vehicles. Moreover, the objective of this invention is to improve the flexibility of the layout of a torque transmission portion in the power transmission device for vehicles.

### BRIEF SUMMARY

A power transmission device for a vehicle according to one aspect of the present invention comprises a first rotating member, a second rotating member, a torque transmission portion, and a hydraulic pressure applying portion. The second rotating member is configured to rotate relative to the first rotating member. The torque transmission portion is disposed between the first rotating member and the second rotating member. The torque transmission portion is configured to transmit torque from one of the first rotating member and the second rotating member to the other of the first rotating member and the second rotating member by pressure of hydraulic fluid. The hydraulic pressure applying portion is configured to apply pressure to the hydraulic fluid of the torque transmission portion.

In this power transmission device, the hydraulic pressure applying portion can set the rigidity during torque transmission by applying pressure to the hydraulic fluid of the torque transmission portion. In other words, in this power transmission device, the rigidity during the torque transmission can be easily set.

Moreover, in this power transmission device, without using a spring as in the prior art, in the torque transmission portion, torque can be transmitted from one of the first rotating member and the second rotating member to the other of the first rotating member and the second rotating member. Therefore, the power transmission device can be reduced in size and weight and can improve the flexibility of the layout of the torque transmission portion.

The power transmission device for the vehicle according to another aspect of the present invention preferably further comprises an oil passage portion configured to connect the torque transmission portion and the hydraulic pressure applying portion.

With this configuration, it is possible to suitably apply pressure to the hydraulic fluid of the torque transmission portion by the hydraulic pressure applying portion.

The power transmission device for the vehicle according to another aspect of the present invention preferably further comprises a hydraulic pressure relieving portion. The hydraulic pressure relieving portion is configured to relieve pressure fluctuation of the hydraulic fluid of the torque transmission portion.

In this case, the torque fluctuation can be attenuated by relieving the pressure fluctuation of the hydraulic fluid in the hydraulic pressure relieving portion.

In the power transmission device for the vehicle according to another aspect of the present invention preferably further comprises an oil passage portion configured to connect the torque transmission portion and the hydraulic pressure applying portion. The hydraulic pressure relieving portion is provided in the oil passage portion between the torque transmission portion and the hydraulic pressure applying portion.

With this configuration, it is possible to suitably attenuate the torque fluctuation by changing pressure of the hydraulic fluid in the hydraulic pressure relieving portion.

In the power transmission device for the vehicle according to another aspect of the present invention, the hydraulic pressure applying portion is preferably configured to apply the pressure of the hydraulic fluid to the torque transmission portion according to vehicle travel information.

With this configuration, it is possible to apply pressure to the hydraulic fluid of the torque transmission portion in accordance with the vehicle travel information. Therefore, torque can be suitably transmitted from one of the first rotating member and the second rotating member to the other of the first rotating member and the second rotating member.

In the power transmission device for the vehicle according to another aspect of the present invention, the torque transmission portion is preferably provided on the first rotating member so as rotate integrally with the first rotating member.

In this case, when torque is input to the first rotating member, the torque transmission portion rotates integrally with the first rotating member. In other words, torque can be transmitted from the first rotating member to the second rotating member via the hydraulic fluid of the torque transmission portion by the rotation of the first rotating member and the torque transmission portion.

In the power transmission device for the vehicle according to another aspect of the present invention, the torque transmission portion preferably includes an oil chamber portion and a pair of pistons. The hydraulic fluid is filled in the oil chamber portion. The pair of pistons encapsulates the hydraulic fluid in the oil chamber portion. The pair of pistons are arranged to move in the oil chamber portion in a rotation direction. The torque is transmitted from the first rotating member to the second rotating member when one of the pair of pistons presses the second rotating member.

With this configuration, torque can be suitably transmitted from the first rotating member to the second rotating member via the torque transmission portion.

In the present invention, in the power transmission device for a vehicle, the rigidity during torque transmission can be easily set. Further, in the present invention, the power transmission device for a vehicle can be reduced in size and weight and can improve the flexibility of the layout of the torque transmission portion.

### BRIEF DESCRIPTION OF THE DRAWINGS

FIG. 1 is a cross-sectional view of a torque converter including a power transmission device according to a first embodiment.

FIG. 2 is a front view of the torque converter according to the first embodiment.

FIG. 3 is a flowchart showing a control mode of average hydraulic pressure according to the first embodiment.

FIG. 4 is a front view of a torque converter according to a second embodiment.

FIG. 5 is a flowchart showing a control mode of average hydraulic pressure according to the second embodiment.

FIG. 6 is a flowchart showing a control mode of hydraulic pressure fluctuation according to the third embodiment.

FIG. 7 is a front view of a torque converter according to a fourth embodiment.

FIG. 8 is a flowchart showing a control mode of hydraulic pressure fluctuation according to the fourth embodiment.

### DETAILED DESCRIPTION

### First Embodiment

### <Configuration of Power Transmission Device>

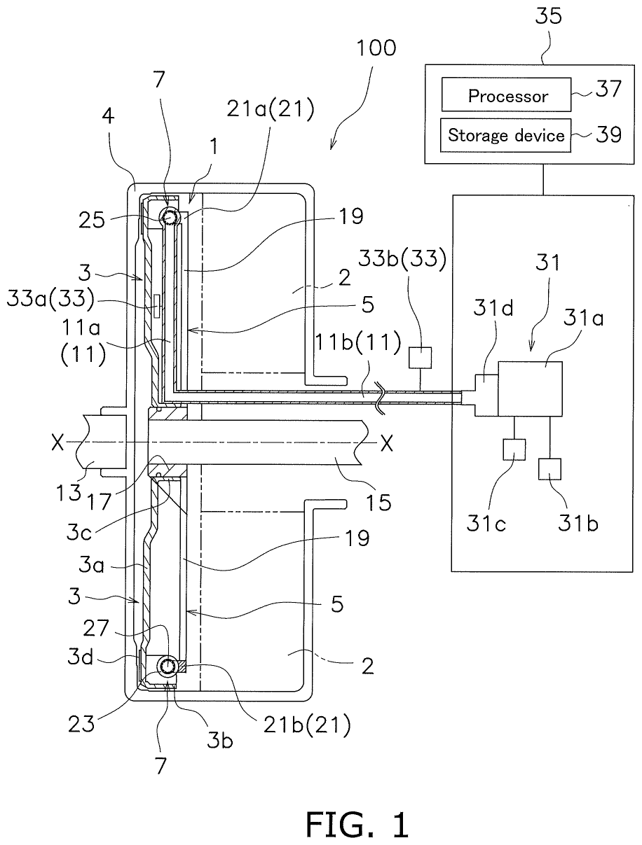

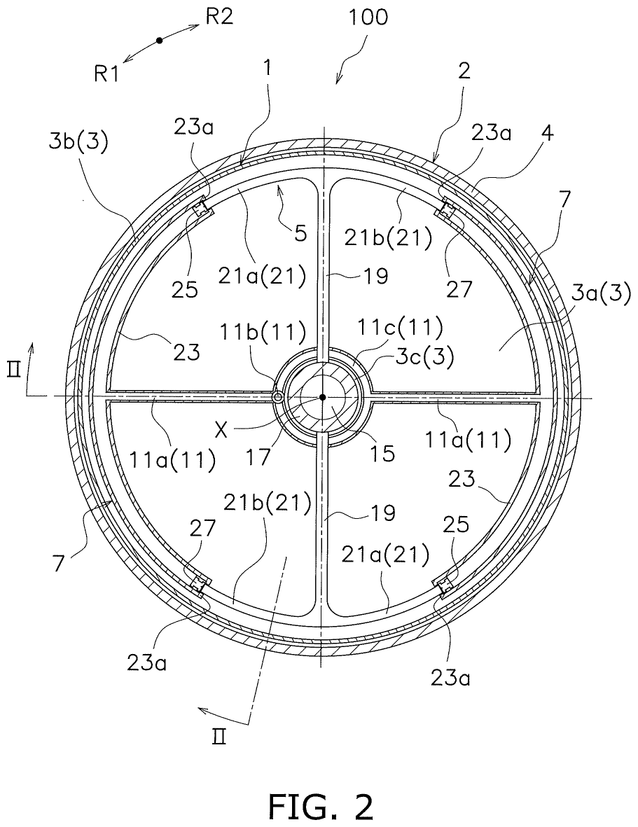

FIG. 1 is a cross-sectional view schematically showing the torque converter 100. FIG. 2 is a front view schematically showing the torque converter 100.

As shown in FIG. 1, the torque converter 100 includes a power transmission device 1 and a torque converter body 2. The torque converter body 2 is connected to the output shaft 15. A front cover 4 is fixed to the torque converter body 2. Since the configuration of the torque converter body 2 is substantially the same as the conventional configuration, the description thereof is omitted here.

As shown in FIG. 1, the power transmission device 1 includes an input rotating member 3 (an example of a first rotating member), an output rotating member 5 (an example of a second rotating member), a torque transmission portion 7, and a hydraulic pressure applying portion 31.

Specifically, the power transmission device 1 includes an input rotating member 3, an output rotating member 5, at least one torque transmission portion 7, an oil passage portion 11, and a hydraulic pressure applying portion 31. The power transmission device 1 includes a rotational axis X. Hereinafter, a direction along the rotational axis X is described as an axial direction, and a direction away from the rotational axis X is described as a radial direction. A direction around the rotational axis X is described as rotation directions R1 and R2 (see FIG. 2).

### (Input Rotating Member)

Torque is input to the input rotating member 3. The input rotating member 3 is disposed on the engine side. As shown in FIG. 1, torque from the engine is input to the input rotating member 3 via the input shaft 13. Further, the torque fluctuation from the engine is input to the input rotating member 3 via the input shaft 13.

Specifically, as shown in FIGS. 1 and 2, torque from the engine is input to the input rotating member 3 from the front cover 4 to which the input shaft 13 (see FIG. 1) is fixed. A torque fluctuation from the engine is input to the input rotating member 3 from the front cover 4 to which the input shaft 13 is fixed.

Specifically, the input rotating member 3 includes main body portion 3a formed in a disc-shape, an outer peripheral annular portion 3b extending from an outer peripheral portion of the main body portion 3a in the axial direction, and a first boss portion 3c extending from an inner peripheral portion of the main body portion 3a in the axial direction. A friction member 3d is fixed to the main body portion 3a. The first boss portion 3c is disposed so as to rotate in the rotation directions R1 and R2 and move in the axial direction with respect to the outer peripheral surface of the second boss portion 17 (described later) of the output rotating member 5.

### (Output Rotating Member)

The output rotating member 5 is configured to rotate relative to the input rotating member 3. Specifically, the output rotating member 5 is disposed on the transmission side. Torque is transmitted from the input rotating member 3 to the output rotating member 5 via the torque transmission portion 7. This torque is output from the output rotating member 5 to the output shaft 15.

Specifically, as shown in FIGS. 1 and 2, the output rotating member 5 includes a second boss portion 17, a pair of arm portions 19 extending from the second boss portion 17 in the radial direction, and a pressed portion 21 extending from a tip end portion (an end portion on the outer peripheral side) of each of the arm portions 19 toward the torque transmission portion 7. The output shaft 15 is fixed to the inner peripheral surface of the second boss portion 17. Each of the arm portions 19 connects the second boss portion 17 and the pressed portion 21.

The pressed portion 21 is a portion pressed by the torque transmission portion 7. The pressed portion 21 includes a plurality (for example, two) of first protruding portions 21a and a plurality (for example, two) of second protruding portions 21b.

As shown in FIG. 2, each of the first protruding portions 21a protrudes in circular arc shape from a tip end portion of each of the arm portions 19 in the first rotation direction R1. The tip end portion of each of the first protruding portions 21a abuts on a first piston 25 (described later) of the torque transmission portion 7.

Each of the second protruding portions 21b protrudes in an arc shape from the tip end portion of each of the arm portions 19 in the second rotation direction R2 opposite to the first rotation direction R1. The tip end portion of each of the second protruding portions 21b abuts on a second piston 27 (described later) of the torque transmission portion 7.

### (Torque Transmission Portion)

As shown in FIG. 1, the torque transmission portion 7 is disposed between the input rotating member 3 and the output rotating member 5. The torque transmission portion 7 transmits torque from the input rotating member 3 to the output rotating member 5 by hydraulic pressure (an example of pressure of hydraulic fluid). The torque transmission portion 7 is provided on the input rotating member 3 so as to rotate integrally with the input rotating member 3. In the embodiment, an example in which at least one torque transmission portion 7 is a plurality (for example, two) of torque transmission portions 7 is illustrated.

Specifically, as shown in FIGS. 1 and 2, each of the torque transmission portions 7 includes a cylinder portion 23 (an example of an oil chamber portion) in which the hydraulic fluid is filled, and first and second pistons 25, 27 (an example of a pair of pistons) for encapsulating the hydraulic fluid in the cylinder portions 23.

Each of the cylinder portions 23 is a tubular member which is substantially curved in an arc shape. The internal space of each of the cylinder portions 23 is filled with the hydraulic fluid. Each of the cylinder portions 23 is disposed between the input rotating member 3 and the output rotating member 5. Each of the cylinder portions 23 is fixed to the input rotating member 3, for example, the main body portion 3a. Each of the cylinder portions 23 is arranged at intervals in the rotation direction R1, R2.

As shown in FIG. 2, a retaining portion 23a for retaining the first and second pistons 25, 27 respectively is provided at both ends of each of the cylinder portions 23. The retaining portion 23a protrudes inward from both ends of each of the cylinder portions 23. For example, the retaining portion 23a is formed in an annular shape.

The first piston 25 is arranged so as to move in the rotation directions R1 and R2 on each of the cylinder portions 23. The first piston 25 is disposed in the internal space of each of the cylinder portions 23 on one end side of each of the cylinder portions 23. The first piston 25 is arranged in the internal space of each of the cylinder portions 23 so as to face the tip end portion of the first protruding portion 21a.

The first piston 25 contacts the tip end portion of the first protruding portion 21a. Torque is transmitted from the input rotating member 3 to the output rotating member 5 when the first piston 25 presses the first protruding portion 21a. The retaining portion 23a prevents the first piston 25 from detached from each of the cylinder portions 23.

The second piston 27 is disposed in each of the cylinder portions 23 so as to move in the rotation directions R1, R2. The second piston 27 is disposed in the internal space of each of the cylinder portions 23 on the other end side of each of the cylinder portions 23. The second piston 27 is arranged in the internal space of each of the cylinder portions 23 so as to face the tip end portion of the second protruding portion 21b.

The second piston 27 contacts the tip end portion of the second protruding portion 21b. The torque is transmitted from the input rotating member 3 to the output rotating member 5 when the second piston 27 presses the second protruding portion 21b. The retaining portion 23a prevents the second piston 27 from detached from each of the cylinder portions 23.

### (Oil Passage Portion)

As shown in FIG. 1, the oil passage portion 11 connects the torque transmission portion 7 and the hydraulic pressure applying portion 31. A hydraulic pressure relieving portion 33 (described later) is provided on the oil passage portion 11 between the torque transmission portion 7 and the hydraulic pressure applying portion 31.

Specifically, as shown in FIGS. 1 and 2, the oil passage portion 11 includes a first oil passage portion 11a extending radially inward from each of the cylinder portions 23, and a second oil passage portion 11b extending from the first oil passage portion 11a in the axial direction.

As shown in FIG. 1, a hydraulic pressure applying portion 31 is connected to the tip end of the second oil passage portion 11b. The first oil passage portions 11a are connected to each other by a connecting oil passage portion 11c (see FIG. 2). Specifically, a hydraulic chamber 31a (described later) is connected to the tip end of the second oil passage portion 11b via a balance piston 31d (described later) of the hydraulic pressure applying portion 31.

The first oil passage portion 11a is connected to a one-way valve 33a (described later) for suction in the hydraulic pressure relieving portion 33. A one-way valve 33b (described later) for discharge in hydraulic pressure relieving portion 33 is connected to the second oil passage portion 11b.

### (Hydraulic Pressure Applying Portion)

The hydraulic pressure applying portion 31 applies hydraulic pressure to the hydraulic fluid of the torque transmission portion 7. For example, as shown in FIG. 1, the hydraulic pressure applying portion 31 includes a hydraulic chamber 31a, an electric pump portion 31b, a relief valve 31c, and a balance piston 31d. The hydraulic fluid is filled in the hydraulic chamber 31a. The electric pump portion 31b supplies the hydraulic fluid to the hydraulic chamber 31a. The relief valve 31c discharges the hydraulic fluid from the hydraulic chamber 31a.

The balance piston 31d is disposed between the cylinder portion 23 of the torque transmission portion 7 and the hydraulic chamber 31a. Specifically, the balance piston 31d is disposed between the second oil passage portion 11b of the oil passage portion 11 and the hydraulic chamber 31a.

Balance piston 31d transmits the hydraulic pressure of the hydraulic fluid of the cylinder portion 23 of the torque transmission portion 7 to the hydraulic fluid of the hydraulic chambers 31a via the oil passage portion 11. Also, the balance piston 31d transmits the hydraulic pressure of the hydraulic fluid of the hydraulic chambers 31a to the hydraulic fluid of the cylinder portion 23 of the torque transmission portion 7 via the oil passage portion 11.

Here, when the hydraulic fluid is supplied from the electric pump portion 31b to the hydraulic chamber 31a, the hydraulic fluid of the hydraulic chamber 31a is discharged from the relief valve 31c according to the supply amount of the hydraulic fluid. Thereby, the hydraulic pressure (average hydraulic pressure) of the hydraulic chamber 31a is kept substantially constant.

Since the average hydraulic pressure of the hydraulic chamber 31a is transmitted to the oil passage portion 11 and the cylinder portion 23 via the balance piston 31d, the hydraulic pressure of the oil passage portion 11 and the hydraulic pressure of the cylinder portion 23 are the substantially same as the average hydraulic pressure of the hydraulic chamber 31a.

### (Hydraulic Pressure Relieving Portion)

The hydraulic pressure relieving portion 33 relieves the hydraulic pressure fluctuation of the hydraulic fluid of the torque transmission portion 7. The hydraulic pressure relieving portion 33 includes the one-way valve 33a for suction and the one-way valve 33b for discharge.

The one-way valve 33a for suction sucks the hydraulic fluid from the outside of the first oil passage portion 11a to the inside of the first oil passage portion 11a. The one-way valve 33b for discharging discharges the hydraulic fluid from the inside of the second oil passage portion 11b to the outside of the second oil passage portion 11b.

Here, when the torque fluctuation is transmitted from the input rotating member 3 to the torque transmission portion 7, the hydraulic pressure fluctuation corresponding to the torque fluctuation generates in the cylinder portion 23 and the oil passage portion 11.

For example, when the positive torque fluctuation is input to the torque transmission portion 7, the first piston 25 or the second piston 27 is pressed by the output rotating member 5. Thereby, the hydraulic pressure of the cylinder portion 23 and the oil passage portion 11 becomes larger than the average hydraulic pressure of the hydraulic chamber 31a, because the volume of the cylinder portion 23 becomes small.

In this case, the hydraulic fluid of the oil passage portion 11 is discharged from the one-way valve 33b for discharge, and the hydraulic pressure in the cylinder portion 23 and the oil passage portion 11 decreases toward the average hydraulic pressure. Thereafter, when the volume of the cylinder portion 23 recovers, the hydraulic fluid is sucked into the oil passage portion 11 from the one-way valve 33a for suction.

On the other hand, when a negative torque fluctuation is input to the torque transmission portion 7, the pressing force of the output rotating member 5 respect to the first piston 25 or the second piston 27 decreases. Thereby, the hydraulic pressure of the cylinder portion 23 and the oil passage portion 11 becomes smaller than the average hydraulic pressure of the hydraulic chamber 31a, because the volume of the cylinder portion 23 becomes large.

In this case, the hydraulic fluid is sucked from the one-way valve 33a for suction into the oil passage portion 11, and the hydraulic pressure in the cylinder portion 23 and the oil passage portion 11 rises toward the average hydraulic pressure. Thereafter, when the volume of the cylinder portion 23 recovers, the hydraulic fluid of the oil passage portion 11 is discharged from the one-way valve 33b for discharge.

The torque fluctuation on the positive side includes a value larger than the average torque on the basis of the average torque transmitted from the input rotating member 3 to the torque transmission portion 7. The negative torque fluctuation includes a value smaller than the average torque on the basis of the average torque. The average torque is a torque that balances the average hydraulic pressure.

The average torque is estimated based on vehicle travel information data, for example, rotation number data of the engine and/or throttle opening data. In this case, the rotation number data of the engine and/or the throttle opening data are detected by, for example, a sensor (not shown). The data detected by the sensor is recorded in a storage device 39 (described later) as sensor detection data. Map data indicating the relationship between the sensor detection data and the average torque is recorded in the storage device 39 in advance. When a relational expression is used instead of the map data, the relational expression indicating the relation between the sensor detection data and the average torque is recorded in the storage device 39 in advance.

### <Setting of the Average Hydraulic Pressure in the Power Transmission Device>

As shown in FIG. 1, the power transmission device 1 further includes a hydraulic pressure management portion 35 that manages the hydraulic pressure of the hydraulic pressure applying portion 31. The hydraulic pressure management portion 35 functions as a controller. For example, the hydraulic pressure management portion 35 instructs various commands to the hydraulic pressure applying portion 31 in order to set the hydraulic pressure which is applied to the hydraulic fluid of the torque transmission portion 7.

The hydraulic pressure management portion 35 includes a processor 37 and a storage device 39. The processor 37 includes at least one CPU (Central Processing Unit). The processor 37 instructs various commands to the hydraulic pressure applying portion 31 based on management program and management data used when the management program is performed.

In the present embodiment, description will be given using an example in which the processor 37 is configured by one CPU. In the present embodiment, an example in which the processor 37 is configured by one CPU is illustrated, but the processor 37 can be configured by a plurality of CPUs. In this case, devices, sensors, and the like that are the targets of the processor 37 are managed by at least one of the plurality of CPUs.

The storage device 39 is an example of a non-transitory recording medium that can be read by the processor 37. The storage device 39 includes, for example, a semiconductor memory and/or a magnetic disk. Specifically, the storage device 39 includes, for example, a RAM (Random Access Memory) and/or a ROM (Read Only Memory). The storage device 39 can include, for example, a magnetic disk and an optical disk.

The storage device 39 records the management programs and the management data. The management data includes basic data necessary for executing the management program and generated data generated during the execution of the management program, and the like. The basic data includes initial setting data.

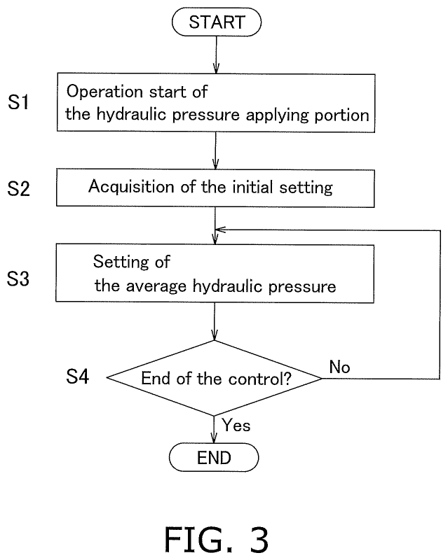

As shown in FIG. 3, firstly, the processor 37 instructs an operation start command to the hydraulic pressure applying portion 31 (S1). Thereby, the initial setting data is read from the storage device 39 and recognized by the processor 37 (S2). The initial setting data includes oil amount data of the hydraulic fluid supplied from the electric pump portion 31b to the hydraulic chamber 31a.

Next, the processor 37 sets the average hydraulic pressure of the hydraulic chamber 31a based on the initial setting data (S3). For example, the processor 37 instructs the electric pump portion 31b on the oil amount to supply to the hydraulic chamber 31a based on the oil amount data of the hydraulic fluid.

Thereby, a predetermined hydraulic fluid is supplied from the electric pump portion 31b to the hydraulic chamber 31a, and the hydraulic fluid of the hydraulic chamber 31a is discharged from the relief valve 31c. As a result, the average hydraulic pressure of the hydraulic chamber 31a is kept substantially constant.

The average hydraulic pressure of the hydraulic chamber 31a is transmitted to the hydraulic fluid of the cylinder portion 23 of the torque transmission portion 7 via the balance piston 31d and the oil passage portion 11. Thereby, the average hydraulic pressure of the hydraulic fluid the cylinder portion 23 is substantially the same as the average hydraulic pressure of the hydraulic chamber 31a. Thus, by setting the average hydraulic pressure of the hydraulic chamber 31a, the average hydraulic pressure of the hydraulic fluid of the cylinder portion 23, that is, the rigidity during torque transmission is set.

Here, when torque is input from the input rotating member 3 to the torque transmission portion 7, the first piston 25 or the second piston 27 is pressed by the output rotating member 5. In this case, since the volume of the cylinder portion 23 becomes small, the hydraulic pressure of the cylinder portion 23 increases. The balance piston 31d is activated by the increase of the hydraulic pressure of the cylinder portion 23. Then, the hydraulic fluid of the hydraulic chamber 31a is discharged from the relief valve 31c.

In this state, as described above, the hydraulic fluid is supplied from the electric pump portion 31b to the hydraulic chamber 31a. Therefore, after the hydraulic fluid is discharged from the relief valve 31c, the hydraulic pressure of the hydraulic chamber 31a is returned to the average pressure as described above by the hydraulic fluid which is supplied from the electric pump portion 31b to the hydraulic chamber 31a. That is, the rigidity during torque transmission is set to the above rigidity.

The initial setting data, for example, the oil amount data of the hydraulic fluid which is supplied from the electric pump portion 31b to the hydraulic chamber 31a, is preferably set according to the type of vehicle and the exhaust amount. It is also preferable to set the opening amounts of the one-way valve 33a for suction and the one-way valve 33b for discharge according to the type of vehicle and the exhaust amount.

In the first embodiment, an example in which the hydraulic pressure applying portion 31 includes the electric pump portion 31b has been described. However, a mechanical pump portion can be used instead of the electric pump portion 31b. In this case, the power transmission device 1 can be operated without using the hydraulic pressure management portion 35. For example, the power transmission device 1 can be operated by causing the mechanical pump portion to supply a predetermined amount of oil to the hydraulic chamber 31a.

Finally, the processor 37 determines whether or not to end the control of the average hydraulic pressure (S4). Here, when the control of the average hydraulic pressure is finished (Yes in S4), the control of the average hydraulic pressure is finished. When the control of the average hydraulic pressure is not finished (No in S4), the above-described processing in Step 3 (S3) is performed again.

### <Operation of the Power Transmission Device>

The power transmission device 1 operates as follows. In the state that the torque from the engine is input to the front cover 4 of the torque converter 100 via the input shaft 13, when the friction member 3d comes into contact with the front cover 4, the power transmission device 1 starts operating. In other words, the power transmission device 1 operates in the lock-up state. On the other hand, when the friction member 3d is separated from the front cover 4, the power transmission device 1 does not operate and the torque converter body 2 operates.

When the input rotating member 3 rotates in the lock-up state, the torque transmission portion 7 rotates with the input rotating member 3. Then, as described above, the hydraulic pressure of the hydraulic fluid of the torque transmission portion 7 is controlled by the hydraulic pressure applying portion 31.

In this state, when the input rotating member 3 and the torque transmission portion 7 rotate in the first rotation direction R1 or the second rotation direction R2, the torque transmission portion 7 presses the output rotating member 5. Thereby, torque is transmitted from the input rotating member 3 to the output rotating member 5 via the torque transmission portion 7.

Specifically, when the input rotating member 3 and the torque transmission portion 7 rotate in the second rotation direction R2, the first piston 25 of the torque transmission portion 7 abuts against the pressed portion 21 of the output rotating member 5, for example, the tip end portion of the first protruding portion 21a. In this state, the first piston 25 presses the tip end portion of the first protruding portion 21a. Further, the first piston 25 moves in the cylinder portion 23 in the first rotation direction R1 according to the hydraulic pressure of the cylinder portion 23. In this case, the second piston 27 leaves from the tip end portion of the second protruding portion 21b. Thereby, torque is transmitted from the input rotating member 3 to the output rotating member 5 via the torque transmission portion 7.

On the other hand, when the input rotating member 3 and the torque transmission portion 7 rotate in the first rotation direction R1, the second piston 27 of the torque transmission portion 7 abuts against the pressed portion 21 of the output rotating member 5, for example, the tip end portion of the second protruding portion 21b. In this state, the second piston 27 presses the tip end portion of the second protruding portion 21b. Further, the second piston 27 moves in the cylinder portion 23 in the second rotation direction R2 according to the hydraulic pressure of the cylinder portion 23. In this case, the first piston 25 leaves from the tip end portion of the first protruding portion 21a. Thereby, torque is transmitted from the input rotating member 3 to the output rotating member 5 via the torque transmission portion 7.

Here, when torque is transmitted from the input rotating member 3 to the output rotating member 5 via the torque transmission portion 7, as described above, the hydraulic pressure of the hydraulic fluid of the torque transmission portion 7 is controlled to the hydraulic pressure applying portion 31. The rigidity during operation of the power transmission device 1 is set by the hydraulic control of the hydraulic fluid in the torque transmission portion 7. Further, the torque fluctuation during the operation of the power transmission device 1 is attenuated by the hydraulic control of the hydraulic fluid in the torque transmission portion 7.

In the power transmission device 1 that operates in this way, the hydraulic pressure applying portion 31 can change the rigidity during torque transmission by controlling the hydraulic pressure of the hydraulic fluid in the torque transmission portion 7. That is, in the power transmission device 1, the rigidity of the torque transmission portion 7 can be easily set.

Further, in the power transmission device 1, torque can be transmitted from the input rotating member 3 to the output rotating member 5 on the torque transmission portion 7 by controlling the hydraulic pressure of the hydraulic fluid in the torque transmission portion 7 without using a spring as in the prior art. For this reason, compared with a prior art, size reduction and weight reduction of the power transmission device 1 can be achieved, and the flexibility of the layout of the torque transmission portion 7 can be improved.

### Second Embodiment

In the second embodiment, the setting mode of the average hydraulic pressure is different from that of the first embodiment. In the second embodiment, only the configuration different from the first embodiment will be described. The configuration omitted here conforms to the configuration of the first embodiment.

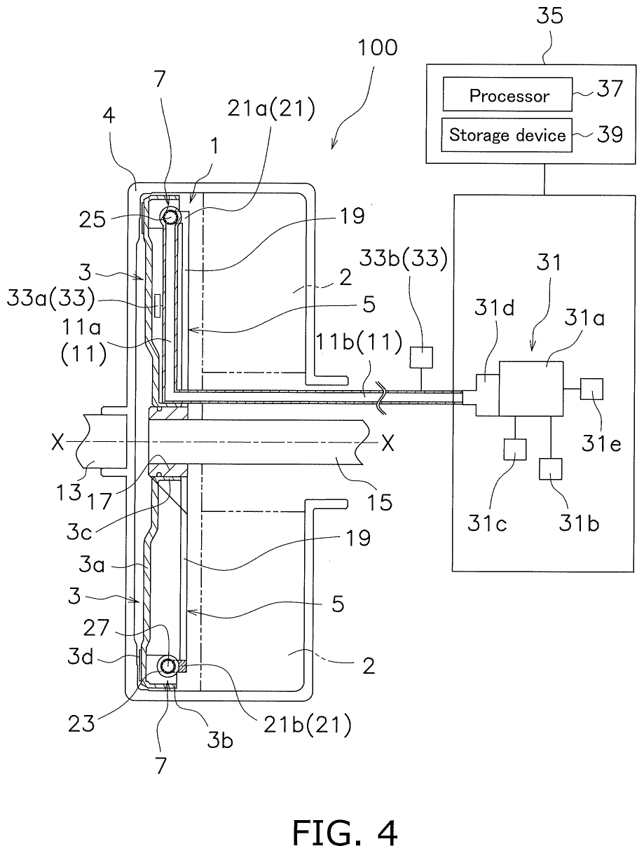

For example, as shown in FIG. 4, the hydraulic pressure applying portion 31 includes a hydraulic chamber 31a, an electric pump portion 31b, a relief valve 31c, a balance piston 31d, and a pressure sensor 31e. The pressure sensor 31e detects the hydraulic pressure in the hydraulic chamber 31a.

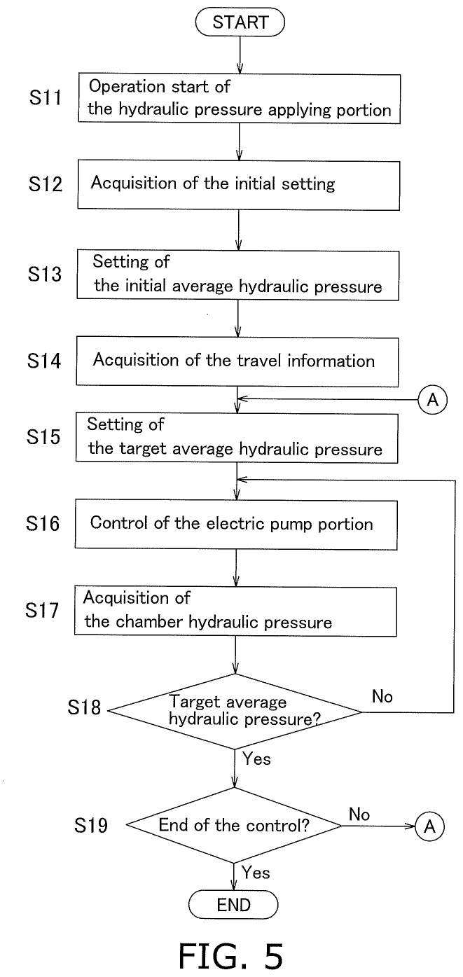

First, as shown in FIG. 5, in the same way as the first embodiment, the processor 37 instructs the hydraulic pressure applying portion 31 on the operation start command (S11). Thereby, the initial setting data is read from the storage device 39 and recognized by the processor 37 (S12). The initial setting data includes oil amount data of hydraulic fluid which is supplied from the electric pump portion 31b to the hydraulic chamber 31a.

Next, the processor 37 sets the initial average hydraulic pressure of the hydraulic chamber 31a based on the initial setting data (S13). For example, the processor 37 instructs the electric pump portion 31b on the oil amount to supply to the hydraulic chamber 31a based on the oil amount data of the hydraulic fluid.

As a result, a predetermined hydraulic fluid is supplied from the electric pump portion 31b to the hydraulic chamber 31a, and the hydraulic fluid of the hydraulic chamber 31a is discharged from the relief valve 31c. Thereby, the initial average hydraulic pressure of the hydraulic chamber 31a is kept substantially constant.

Subsequently, the processor 37 acquires the vehicle travel information data (S14). For example, the vehicle travel information data is acquired by detecting the operation and state of the component members of the power transmission device 1 and the operation and state of the component members of the vehicle with a sensor or the like (not illustrated). The vehicle travel information data is recorded in the storage device 39.

The vehicle travel information data includes, for example, the rotation number data of the engine and/or the throttle opening data. Here, the rotation number data of the engine and/or the throttle opening data are detected by the sensor (not illustrated). The processor 37 acquires the rotation number data of the engine and/or the throttle opening data.

Subsequently, the processor 37 sets a target average hydraulic pressure data of the hydraulic chamber 31a based on the vehicle travel information data (S15). The target average hydraulic pressure data is recorded in the storage device 39. This process is repeated every predetermined period, and the target average hydraulic pressure data is updated. Here, when the processor 37 changes the target average hydraulic pressure in accordance with the vehicle travel information data, the rigidity during operation of the power transmission device 1 is changed.

When the processor 37 sets the target average hydraulic pressure data based on the vehicle travel information data, the processor 37 can set the target average hydraulic pressure data based on the map data indicating the relationship between the vehicle travel information data and the target average hydraulic pressure data. The processor 37 can acquire the target average hydraulic pressure data from the vehicle travel information data by calculation process using the predetermined relational expression.

For example, the processor 37 can estimate the average torque based on the rotation number data of the engine and/or the throttle opening data (sensor detection data). In this case, the processor 37 sets target the average hydraulic pressure data according to the average torque.

The map data indicating the relationship between the sensor detection data and the average torque, and the map data indicating the relationship between the average torque and the target average hydraulic pressure data are recorded in the storage device 39 in advance.

When the relational expression is used instead of the map data, the relational expression indicating the relation between the sensor detection data and the average torque, and the relational expression indicating the relation between the average torque and the target average hydraulic pressure data are recorded in the storage device 39 in advance.

Subsequently, the processor 37 controls the electric pump portion 31b so that the hydraulic pressure of the hydraulic chamber 31a becomes the target average hydraulic pressure corresponding to the target average hydraulic pressure data (S16). For example, the processor 37 operates the electric pump portion 31b and the relief valve 31c by instructing an operation command to the hydraulic pressure applying portion 31. As a result, the hydraulic pressure of the hydraulic chamber 31a changes toward the target average hydraulic pressure.

Subsequently, the processor 37 acquires the hydraulic pressure of the hydraulic chamber 31a (S17). For example, the processor 37 acquires the current hydraulic pressure of the hydraulic chamber 31a by recognizing the current hydraulic pressure data detected by the pressure sensor 31e.

Subsequently, the processor 37 determines whether the current hydraulic pressure of the hydraulic chamber 31a reaches the target average hydraulic pressure (S18). For example, the processor 37 determines whether the current hydraulic pressure data matches the target average hydraulic pressure data. If the current hydraulic pressure data does not match the target average hydraulic pressure data (No in S18), the processor 37 controls the hydraulic pressure applying portion 31 again so that the hydraulic pressure of the hydraulic chamber 31a becomes the target average hydraulic pressure. (S16).

On the other hand, when the current hydraulic pressure data matches the target average hydraulic pressure data (Yes in S18), the processor 37 determines whether or not to end the control of the average hydraulic pressure (S19). Here, when the control of the average hydraulic pressure is finished (Yes in S19), the control of the average hydraulic pressure is finished. On the other hand, when the control of the average hydraulic pressure is not finished (No in S19), the process of step 15 (S15) is performed again.

As an example of the variation, the setting of the target average hydraulic pressure data described above can be performed as follows. For example, the rotation number data of the engine, the throttle opening data, and the average rotation number data of the input rotating member 3 (sensor detection data) can be detected by a sensor (not illustrated).

Based on these sensor detection data, the processor 37 estimates centrifugal hydraulic pressure data when centrifugal force acts on the hydraulic fluid of the cylinder portion 23. Based on the centrifugal hydraulic pressure data, the processor 37 corrects the target average hydraulic pressure data. Here, the processor 37 corrects the target average hydraulic pressure data by subtracting the centrifugal hydraulic pressure data from the target average hydraulic pressure data.

By setting the target average hydraulic pressure data in this way, even if the centrifugal force acts on the hydraulic fluid of the cylinder portion 23, the target average hydraulic pressure data can be set with high accuracy.

In this case, the map data indicating the correspondence between the sensor detection data and the centrifugal hydraulic pressure data is recorded in the storage device 39 in advance. When the relational expression is used instead of the map data, the relational expression indicating the relation between the sensor detection data and the centrifugal hydraulic pressure data is recorded in the storage device 39 in advance.

As another example of the variation, the setting of the target average hydraulic pressure data described above can be performed as follows. For example, average rotation number data of the input rotating member 3, average rotation number data of the output rotating member 5, and rotation number data of the engine (sensor detection data) are detected by a sensor (not illustrated).

Based on these data, the processor 37 calculates the rotational speed ratio between the input rotating member 3 and the output rotating member 5 and the change of the rotation number of the engine.

The processor 37 determines whether the torque converter 100 is in the torque converter coasting state such as inertial traveling based on the rotational speed ratio and the change of the rotation number of the engine. Here, when the torque converter 100 is in the torque converter coast state, the processor 37 sets target average hydraulic pressure data for coasting state as the above target average hydraulic pressure data. On the other hand, when the torque converter 100 is not in the torque converter coast state, the processor 37 maintains the above target average hydraulic pressure data.

Thereby, the target average hydraulic pressure data can be changed according to the state of the torque converter 100. That is, the rigidity during operation of the power transmission device 1 can be changed according to the state of the torque converter 100.

In this case, the map data indicating correspondence between the sensor detection data and the torque converter states (torque coasting state and non-torque coasting state) is recorded in the storage device 39 in advance. In addition, the map data indicating the correspondence between the torque converter state and the target average hydraulic pressure data is recorded in the storage device 39 in advance.

Further, when a determination formula or a relational expression is used instead of the map data, the determination formula for determining the torque converter state based on the sensor detection data is recorded in the storage device 39 in advance. In addition, the relational expression indicating the relationship between the torque converter state and the target average hydraulic pressure data is recorded in the storage device 39 in advance.

As another example of the variation, the setting of the target average hydraulic pressure data described above can be performed as follows.

For example, the processor 37 acquires gear stage data (sensor detection data) selected by the transmission from a transmission processing device. Based on the gear stage data, the processor 37 sets target average hydraulic pressure data. Thereby, the target average hydraulic pressure data can be changed according to the gear stage data of the transmission. That is, the rigidity during operation of the power transmission device 1 can be changed according to the state of the transmission.

In this case, the map data indicating correspondence between the sensor detection data and the target average hydraulic pressure data is recorded in the storage device 39 in advance. When a relational expression is used instead of the map data, the relational expression indicating the relation between the sensor detection data and the target average hydraulic pressure data is recorded in the storage device 39 in advance.

As another example of the variation, the setting of the target average hydraulic pressure data described above can be performed as follows.

For example, temperature data (sensor detection data) of the hydraulic fluid of the hydraulic chamber 31a is detected by a sensor (not illustrated). Based on the sensor detection data, the processor 37 estimates the characteristics of the hydraulic fluid. The target average hydraulic pressure data is corrected based on the current average hydraulic pressure data corresponding to the characteristics of the hydraulic fluid.

By setting the target average hydraulic pressure data in this way, even if the temperature of the hydraulic fluid of the cylinder portion 23 changes, the target average hydraulic pressure data can be set with high accuracy.

In this case, the map data indicating the correspondence between the sensor detection data and the correction value is recorded in the storage device 39 in advance. When a relational expression is used instead of the map data, the relational expression indicating the relation between the sensor detection data and the correction value is recorded in the storage device 39 in advance.

### Third Embodiment

In the third embodiment, the setting mode of the hydraulic pressure fluctuation is different from that of the first and second embodiments. In the third embodiment, only the configuration different from the first and second embodiments will be described. The configuration omitted here conforms to the configuration of the first and second embodiments.

In the third embodiment, the hydraulic pressure applying portion 31 applies hydraulic pressure to the hydraulic fluid of the torque transmission portion 7 and relieves the hydraulic pressure fluctuation of the hydraulic fluid of the torque transmission portion 7.

For example, as shown in FIG. 4, the hydraulic pressure applying portion 31 includes the hydraulic chamber 31a, the electric pump portion 31b, the relief valve 31c, the balance piston 31d, and the pressure sensor 31e. The pressure sensor 31e detects the hydraulic pressure of the hydraulic chamber 31a.

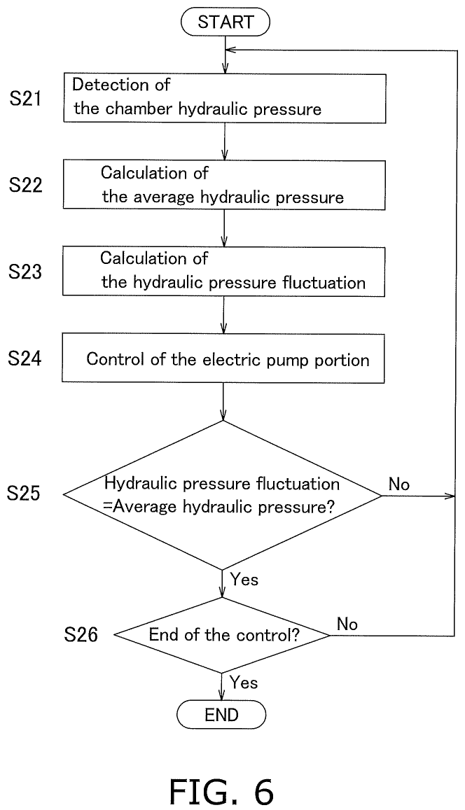

In this case, first, as shown in FIG. 6, the pressure sensor 31e detects the hydraulic pressure data of the hydraulic chamber 31a (S21). This hydraulic pressure data is continuously recorded in the storage device 39. Thereby, time-series data of hydraulic pressure is generated.

Next, the processor 37 calculates average hydraulic pressure data of the hydraulic chamber 31a based on the time series data of hydraulic pressure (S22). Further, the processor 37 calculates the hydraulic pressure fluctuation data of the hydraulic chamber 31a based on the time series data and the average hydraulic pressure data (S23).

The average hydraulic pressure data of the hydraulic chamber 31a corresponds to the average hydraulic pressure of the torque transmission portion 7. The average hydraulic pressure of the torque transmission portion 7 corresponds to the torque transmitted from the input rotating member 3. The hydraulic pressure fluctuation data of the hydraulic chamber 31a corresponds to the hydraulic pressure fluctuation of the torque transmission portion 7. The hydraulic pressure fluctuation of the torque transmission portion 7 substantially corresponds to the torque fluctuation transmitted from the input rotating member 3.

Subsequently, the processor 37 controls the electric pump portion 31b based on the hydraulic pressure fluctuation data of the hydraulic chamber 31a (S24). For example, the processor 37 operates the electric pump portion 31b so that the hydraulic pressure fluctuation data of the hydraulic chamber 31a approaches the average hydraulic pressure data of the hydraulic chamber 31a. More specifically, for example, the processor 37 operates the electric pump portion 31b using a time-series data including antiphase opposite to phase of the hydraulic pressure fluctuation data of the hydraulic chamber 31a.

Here, the processor 37 sets supply amount of the hydraulic fluid from the electric pump portion 31b to the hydraulic chamber 31a according to the hydraulic pressure fluctuation of the hydraulic chamber 31a. The map data indicating the correspondence between the hydraulic pressure fluctuation of the torque transmission portion 7 and the supply amount of the hydraulic fluid is recorded in the storage device 39 in advance. Based on the map data, the processor 37 controls the drive voltage of the electric pump portion 31b. Thereby, the supply amount of the hydraulic fluid from the electric pump portion 31b to the hydraulic chamber 31a is set to a predetermined value.

Subsequently, the processor 37 determines whether the hydraulic pressure fluctuation data of the hydraulic chamber 31a substantially matches the average hydraulic pressure data of the hydraulic chamber 31a (S25). For example, the processor 37 operates the electric pump portion 31b so that the difference between the hydraulic pressure fluctuation data of the hydraulic chamber 31a and the average hydraulic pressure data of the hydraulic chamber 31a is substantially zero.

Subsequently, when the hydraulic pressure fluctuation data of the hydraulic chamber 31a does not substantially match the average hydraulic pressure data of the hydraulic chamber 31a (No in S25), the processor 37 repeatedly performs the above-described processing from step 21 to step 25 (S21 to S25), until the hydraulic pressure fluctuation data of the hydraulic chamber 31a matches the average hydraulic pressure data of the hydraulic chamber 31a.

On the other hand, when the hydraulic pressure fluctuation data of the hydraulic chamber 31a substantially matches the average hydraulic pressure data of the hydraulic chamber 31a (Yes in S25), the processor 37 determines whether or not to end the control of the hydraulic pressure fluctuation. (S26). Here, when the control of the hydraulic pressure fluctuation is ended (Yes in S26), the control of the hydraulic pressure fluctuation is ended. On the other hand, when the control of the hydraulic pressure fluctuation is not finished (No in S26), the process of step 21 (S21) is performed again.

Thus, the hydraulic pressure fluctuation of the hydraulic chamber 31a, that is, the hydraulic pressure fluctuation of the hydraulic fluid of the torque transmission portion 7, can be relieved by operating the electric pump portion 31b. In case that the hydraulic pressure fluctuation of the hydraulic fluid of the torque transmission portion 7 is generated, as described in the first embodiment, the hydraulic pressure fluctuation is relieved by the one-way valve 33a for suction and the one-way valve 33b for discharge.

Here, an example in which the hydraulic pressure fluctuation data is controlled by using the electric pump portion 31b is illustrated, but the above-described control can be performed by using the relief valve 31c.

### Fourth Embodiment

The configuration of the fourth embodiment is different from the first to third embodiments in the setting mode of the hydraulic pressure fluctuation. In the fourth embodiment, only the configuration different from the first to third embodiments will be described. The configuration omitted here conforms to the configuration of the first to third embodiments.

In the fourth embodiment, the hydraulic pressure applying portion 31 applies the hydraulic pressure to the hydraulic fluid of the torque transmission portion 7. The hydraulic pressure relieving portion 33 relieves the hydraulic pressure fluctuation of the hydraulic fluid of the torque transmission portion 7.

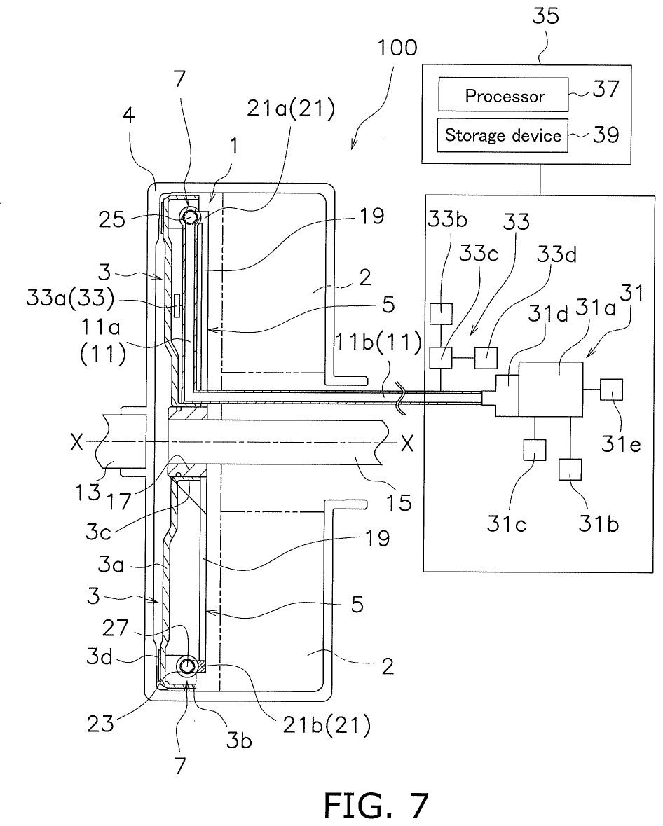

As shown in FIG. 7, the hydraulic pressure relieving portion 33 includes an one-way valve 33a for suction and an one-way valve 33b for discharge. The hydraulic pressure relieving portion 33 further includes a throttle portion 33c for discharging the hydraulic fluid from the one-way valve 33b for discharge, and an actuator 33d for setting the throttle amount of the throttle portion 33c. The actuator 33d is controlled by the processor 37.

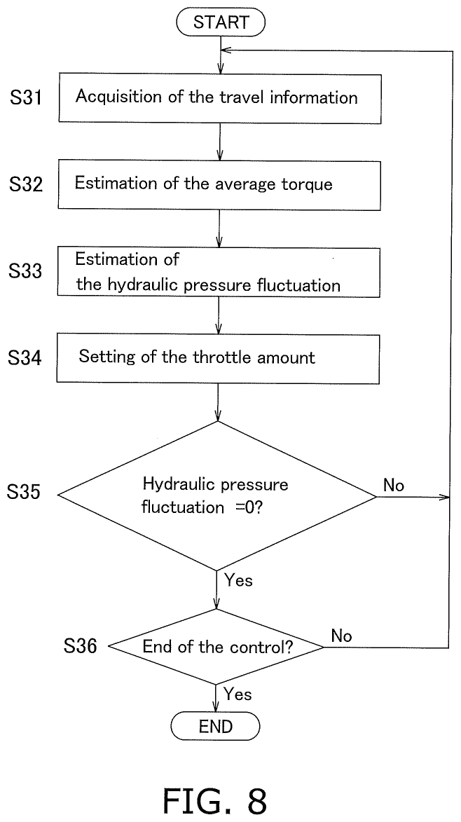

In this case, first, as shown in FIG. 8, the processor 37 acquires the vehicle travel information data, for example, the rotation number data of the engine and/or the throttle opening data (sensor detection data) (S31). Next, as shown in the first embodiment, the processor 37 estimates an average torque based on the vehicle travel information data, for example, the rotation number data of the engine and/or the throttle opening data (sensor detection data) (S32).

Subsequently, the processor 37 estimates the hydraulic pressure fluctuation data of the hydraulic fluid of the torque transmission portion 7 based on the average torque (S33). For example, the processor 37 estimates the hydraulic pressure fluctuation data based on the map data indicating the correspondence between the average torque and the hydraulic pressure fluctuation data. The map data indicating the correspondence between the average torque and the hydraulic pressure fluctuation data is recorded in the storage device 39. When a relational expression is used instead of the map data, the relational expression indicating the relation between the average torque and the hydraulic pressure fluctuation data is recorded in the storage device 39 in advance.

Subsequently, the processor 37 sets the throttle amount of the throttle portion 33c based on the hydraulic pressure fluctuation data of the hydraulic fluid of the torque transmission portion 7 (S34). For example, the processor 37 sets the throttle amount of the throttle portion 33c according to the hydraulic pressure fluctuation indicated by the hydraulic pressure fluctuation data.

Specifically, the processor 37 instructs the actuator 33d on drive voltage so that the throttle portion 33c becomes the throttle amount corresponding to the hydraulic pressure fluctuation. Thereby, the throttle amount of the throttle portion 33c is set to the throttle amount corresponding to the hydraulic pressure fluctuation.

Here, the processor 37 sets the throttle amount of the throttle portion 33c based on the map data indicating the correspondence between the hydraulic pressure fluctuation data and the drive voltage of the actuator 33d. The map data indicating the correspondence between the hydraulic pressure fluctuation data and the drive voltage of the actuator 33d is recorded in the storage device 39. When a relational expression is used instead of the map data, the relational expression indicating the relation between the hydraulic pressure fluctuation data and the drive voltage of the actuator 33d is recorded in the storage device 39.

In a state in which the throttle amount is set on the throttle portion 33c as described above, when the hydraulic pressure fluctuation on the positive side in the hydraulic fluid of the torque transmission portions 7 is generated, the hydraulic fluid of the oil passage portion 11 is discharged from the one-way valve 33b for discharge. On the other hand, when the hydraulic pressure fluctuation on the negative side of the hydraulic fluid of the torque transmission portion 7 is generated, the hydraulic fluid of the oil passage portion 11 is sucked from the one-way valve 33a for suction.

Thus, the hydraulic pressure fluctuation of the hydraulic chamber 31a, that is, the hydraulic pressure fluctuation of the hydraulic fluid of the torque transmission portion 7 can be relieved by operating the one-way valve 33b for discharge and the one-way valve 33a for suction.

Subsequently, the processor 37 determines whether the hydraulic pressure fluctuation of the hydraulic chamber 31a detected by the pressure sensor 31e becomes substantially zero (S35). Here, when the hydraulic pressure fluctuation of the hydraulic chamber 31a is not substantially zero (No in S35), the above processing from Step 31 to Step 35 (S31 to S35) is repeatedly performed.

On the other hand, when the hydraulic pressure fluctuation of the hydraulic chamber 31a becomes substantially zero (Yes in S35), the processor 37 determines whether or not to end the control of the hydraulic pressure fluctuation (S36). Here, when the control of the hydraulic pressure fluctuation is ended (Yes in S36), the control of the hydraulic pressure fluctuation is ended. On the other hand, when the control of the hydraulic pressure fluctuation is not ended (No in S36), the process of step 31 (S31) is performed again.

### Other Embodiments

The present invention is not limited to the above embodiments, and various changes or corrections can be made without departing from the scope of the present invention.

(A) In the above embodiment, an example in which the power transmission device 1 is applied to the torque converter 100 is indicated. However, the power transmission device 1 can be applied to other configurations as long as the power transmission device 1 exists on a power transmission path for a vehicle.

(B) In the above-described embodiment, an example in which the hydraulic pressure of the torque transmission portion 7 is controlled by using the hydraulic chamber 31a is indicated. However, hydraulic pressure control of the torque transmission portion 7 can be performed by pressurizing means except for the hydraulic chamber 31a, for example, an actuator or the like. The detection process of the hydraulic pressure can be performed by detecting the average torque and the torque fluctuation which input to the input rotating member 3.

(C) Each component of the power transmission device 1 illustrated in the above embodiment can include any configuration, if torque can be transmitted from the input rotating member 3 to the output rotating member 5 with pressure of the hydraulic fluid in the torque transmission portion 7.

(D) In the above embodiment, an example in which the torque fluctuation is transmitted from the input rotating member 3 to the output rotating member 5 is indicated. However, the torque fluctuation can be attenuated in case that the torque fluctuation is transmitted from the output rotating member 5 to the input rotating member 3.

### REFERENCE SIGNS LIST

1 Power transmission device
3 Input rotating member
5 Output rotating member
7 Torque transmission portion
23 Cylinder portion
25 First piston
27 Second piston
31 Hydraulic pressure applying portion
33 Hydraulic pressure relieving portion
11 Oil passage portion
11a First oil passage
11b Second oil passage
11c Connecting oil passage

What is claimed is:

1. A power transmission device for a vehicle comprising:
a first rotating member;
a second rotating member configured to rotate relative to the first rotating member;
a torque transmission portion configured to transmit torque from one of the first rotating member and the second rotating member to the other of the first rotating member and the second rotating member by pressure of hydraulic fluid, the torque transmission portion disposed between the first rotating member and the second rotating member; and
a hydraulic pressure applying portion configured to apply pressure to the hydraulic fluid of the torque transmission portion.

2. The power transmission device for the vehicle according to claim 1, further comprising:
an oil passage portion configured to connect the torque transmission portion and the hydraulic pressure applying portion.

3. The power transmission device for the vehicle according to claim 1, further comprising:
a hydraulic pressure relieving portion configured to relieve pressure fluctuation of the hydraulic fluid of the torque transmission portion.

4. The power transmission device for the vehicle according to claim 3, further comprising:
an oil passage portion configured to connect the torque transmission portion and the hydraulic pressure applying portion, wherein
the hydraulic pressure relieving portion is provided in the oil passage portion between the torque transmission portion and the hydraulic pressure applying portion.

5. The power transmission device for the vehicle according to claim 1, wherein
the hydraulic pressure applying portion is configured to apply the pressure of the hydraulic fluid to the torque transmission portion according to vehicle travel information.

6. The power transmission device for the vehicle according to claim 1, wherein
the torque transmission portion is provided on the first rotating member so as rotate integrally with the first rotating member.

7. The power transmission device for the vehicle according to claim 6, wherein
the torque transmission portion includes an oil chamber portion and a pair of pistons, the hydraulic fluid filled in the oil chamber portion, the pair of pistons encapsulating the hydraulic fluid in the oil chamber portion,
the pair of pistons are arranged to move in the oil chamber portion in a rotation direction,
the torque is transmitted from the first rotating member to the second rotating member when one of the pair of pistons presses the second rotating member.
